(19) United States
(12) Patent Application Publication
(10) Pub. No.: US 2005/0223529 A1
(43) Pub. Date: Oct. 13, 2005

(54) Apparatus and method for tightening laces or other cords

(76) Inventor: Darren McClelland, North Vancouver (CA)

Correspondence Address: Ralph A. Dowell of DOWELL & DOWELL P.C., 2111 Eisenhower Ave., Suite 406, Alexandria, VA, 22314, US

(21) Appl. No.: 10/820,140

(22) Filed: Apr. 8, 2004

(51) Int. Cl. A43C 7/04; F16G 11/00

(52) U.S. Cl. 24/130; 24/712.1

(57) ABSTRACT

Apparatuses and method for tightening a cord. One apparatus includes a body, and a grabber extending from the body and defining a groove therebetween configured to grip the cord therein. Another apparatus includes a body, means for grabbing the cord, and means for gripping the cord between the means for grabbing and the body. A method includes gripping a cord in a groove defined between a grabber of a tightener and a body of the tightener, and pulling the tightener. The cord may include a lace, such as a skatelace.

### BACKGROUND OF THE INVENTION

1. Field of Invention

The present invention relates to cords, and more particularly, to an apparatus and method for tightening laces or other cords.

2. Description of Related Art

Many different applications involve cords that must be manually tightened. For example, laces for ice skates normally have to be tightly tied, in order to provide adequate ankle support. However, it is typically difficult for the skater to insert his or her fingers under each lace portion between successive eyelets. Moreover, once the skater's fingers have been inserted under the relevant lace portion, the laces must be pulled with sufficient force to cause abrasion or other discomfort to the skater's fingers. Similar problems may arise in tightening laces for other types of footwear, or in other applications involving the tightening of other types of cords, such as lines on boats, for example.

A number of devices have been previously proposed or marketed to attempt to assist users in the tightening of laces or other cords. For example, one existing skatelace tightener includes a thin elongated metal hook, attached to a thin metal handle. The hook is inserted under a portion of the lace, and the user pulls the handle to tighten the lace. However, such devices tend to suffer from a number of disadvantages. For example, the thin handle may be difficult for some users to grasp and pull with sufficient force to adequately tighten the lace. This difficulty is further exacerbated for users who lack strong or fully developed finger muscles, such as children or the elderly, for example. The thin handle provides a relatively small surface area for the user to grasp, thereby exerting considerable pressure on the user's hand, which may cause abrasion or other discomfort to the user's skin. The hook itself tends to be somewhat sharp, and may wear the lace as the user attempts to slide the hook under the lace. Once the hook is inserted under the lace and the user pulls the handle to tighten the lace, the hook contacts the lace over a very small surface area, with the result that the hook applies a very large pressure to a particular point on the lace, thereby increasing lace wear and increasing the likelihood of lace breakage. In addition, the hook typically has a smooth metal surface, providing a poor coefficient of friction between the hook and the lace, with the result that the lace may tend to slip, and may even slip out of engagement with the hook as more pressure is applied.

Accordingly, there is a need for an improved way of tightening a lace or other cord.

### SUMMARY OF THE INVENTION

In accordance with one aspect of the invention, there is provided an apparatus for tightening a cord. The apparatus includes a body, and further includes a grabber extending from the body and defining a groove therebetween configured to grip the cord therein.

Advantageously, as the cord is gripped in the groove defined between the grabber and the body, the force applied to the cord tends to be spread over a larger surface area of the cord than if the same total amount of force had been applied by a conventional hook tightener. Thus, the pressure to which any given part of the cord is subjected tends to be lower than pressures resulting from conventional tighteners, thereby reducing wear and reducing the likelihood of breakage of the cord.

The body may have a shape configured to be manually grippable. For example, the body may have a generally cylindrical shape. The body may have a length at least as great as a width of an intended user's hand. For example, the body may have a length of at least one-half decimeter, which may be advantageous for users with small hands such as children. Similarly, the body may have a length of at least one decimeter, which may be advantageous for many adults. The body may have a width of at least one centimeter. For example, the body may have a width of at least two centimeters.

Advantageously, such embodiments tend to be more easily grippable by a user, allowing the user to apply significant amounts of force without the abrasion or other discomfort that tend to result from conventional tighteners.

The grabber may be generally tongue-shaped. The grabber may extend generally circumferentially and radially outwardly from an outer surface of the body at a central region thereof. The grabber may include a base portion at which the grabber merges with the body, and a tip portion narrower than the base portion.

Advantageously, such a grabber tends to more easily slide under a lace or other cord without causing wear. In addition, such a configuration of the grabber extending circumferentially and radially outwardly from the outer surface of the body tends to prevent the cord from becoming dislodged from the groove during tightening, and also allows the cord to be tightened by pulling the body in a direction substantially perpendicular to its axis, tending to prevent the apparatus from slipping out of the user's hand during tightening.

The body and the grabber may be rigid. In this regard, rigidity to resist flexing may be advantageous in assisting the user to more easily apply force to the apparatus to tighten the cord.

The body and the grabber may be formed from a single mold.

The body and the grabber may include an inner core material, such as a plastic and/or a resin, for example.

The body and the grabber may further include an outer coating. The outer coating may include a resiliently deformable material, such as rubber, for example.

Advantageously, such outer coatings tend to reduce abrasion or other discomfort to the user's hands, while also improving the grip of the cord in the groove.

The outer coating may include a material selected to provide a desired amount of friction between the outer coating and the cord. For example, the outer coating may include rubber.

Advantageously, the friction provided by such outer coatings tends to improve the tightening ability of the apparatus.

The apparatus may further include a plurality of teeth extending from at least one of the body and the grabber within the groove. Such embodiments may be useful for applications where lateral slippage of the cord within the groove may tend to occur.

The grabber may be configured to grab the cord. For example, the grabber may be insertable under the cord to grab the cord. The grabber may be generally tongue-shaped and may include a tip portion insertable under the cord to grab the cord. Advantageously, as mentioned above, such a grabber tends to more easily slide under a lace or other cord without causing wear.

The body may be rotatable about a central axis thereof to grip the cord in the groove.

The body may be pullable in a direction non-parallel to the central axis of the body. For example, the body may be pullable in a direction substantially perpendicular to the central axis of the body.

Advantageously, the perpendicularity of the pulling direction relative to the central axis tends to reduce or prevent slippage of the cord in the groove.

The cord may include a lace portion extending between eyelets of a footwear item, and the groove may be configured to grip the lace portion therein.

For example, the cord may include a skatelace portion extending between eyelets of a skate, and the groove may be configured to grip the skatelace portion therein.

In accordance with another aspect of the invention, there is provided a system including first and second apparatuses as described herein, the respective grooves of which are configured to grip first and second respective cord portions therein. For example, the respective grooves of the first and second apparatuses may be configured to grip first and second respective skatelace portions therein.

In accordance with another aspect of the invention, there is provided a method of tightening a cord. The method includes gripping a cord in a groove defined between a grabber of a tightener and a body of the tightener, and pulling the tightener.

Gripping may include grabbing the cord, which may include inserting the grabber under the cord.

Gripping may further include rotating the tightener about a central axis thereof to grip the cord in the groove.

Pulling may include pulling the tightener in a direction non-parallel to the central axis of the tightener. For example, pulling may include pulling the tightener in a direction substantially perpendicular to the central axis of the tightener.

Gripping a cord may include gripping a lace portion extending between eyelets of a footwear item. For example, gripping a lace portion may include gripping a skatelace portion extending between eyelets of a skate.

Gripping may include gripping a first lace portion in a first groove defined between a grabber of a first tightener and a body of the first tightener, and gripping a second lace portion in a second groove defined between a grabber of a second tightener and a body of the second tightener, and pulling may include pulling the first and second tighteners.

In accordance with another aspect of the invention, there is provided an apparatus for tightening a cord. The apparatus includes a body, means for grabbing the cord, and means for gripping the cord between the means for grabbing and the body.

The apparatus may further include means for facilitating pulling of the body.

More generally, the apparatus may further include means for carrying out the various functions described herein.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a bottom elevation view of an apparatus for tightening a cord, according to a first embodiment of the invention;

FIG. 2 is a front elevation view of the apparatus of FIG. 1;

FIG. 3 is a side elevation view of the apparatus of FIG. 1;

FIG. 4 is a perspective view of the apparatus of FIG. 1;

FIG. 5 is a cross-section of the apparatus of FIG. 1;

FIGS. 6-7 are top elevation views of a footwear item, shown with the apparatus of FIG. 1;

FIG. 8-9 are top elevation views of the footwear item of FIG. 6, shown with first and second apparatuses of FIG. 1; and

FIG. 10 is a bottom elevation view of an apparatus for tightening a cord, according to a second embodiment of the invention.

### DETAILED DESCRIPTION

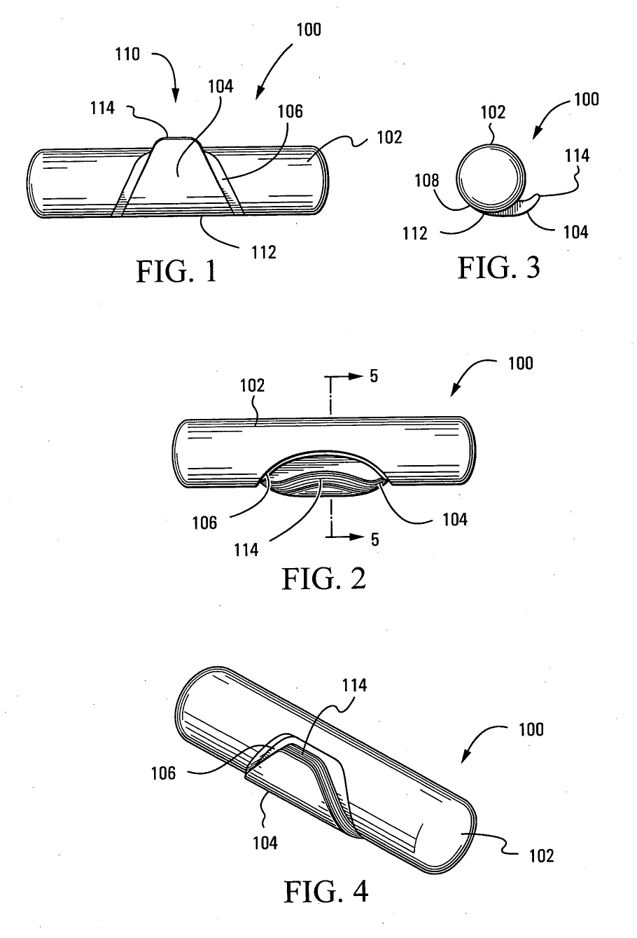

Referring to FIGS. 1-5, an apparatus for tightening a cord according to a first embodiment of the invention is shown generally at 100. In this embodiment, the apparatus 100 includes a body 102, and a grabber 104 extending from the body and defining a groove 106 therebetween configured to grip the cord therein.

As previously mentioned, as the cord is gripped in the groove defined between the grabber and the body, when the body is subsequently pulled to tighten the cord, the force applied to the cord tends to be spread over a larger surface area of the cord than with conventional tighteners, thereby reducing the pressure to which any given part of the cord is subjected, advantageously reducing wear and reducing the likelihood of breakage of the cord.

In this embodiment, the body 102 has a shape configured to be manually grippable. More particularly, in this embodiment the body 102 has a generally cylindrical shape.

In the present embodiment, the body 102 has a length at least as great as a width of an intended user's hand. More particularly, in this embodiment the body 102 has a length of at least one-half decimeter, which is as great as the width of a small child's hand. More particularly still, in this embodiment the body 102 has a length of at least one decimeter, which is at least as great as the width of many adults' hands. More particularly still, in this embodiment the body 102 has a length of 12 centimeters. Although a body length exceeding the width of a user's hand is advantageous as it allows for the apparatus 100 to be more easily gripped and pulled, alternatively, embodiments of the apparatus may be provided in which the body length is less than a user's hand-width, if desired. More generally, other suitable lengths may be substituted if desired.

In this embodiment, the body 102 has a width of at least one centimeter. More particularly, in this embodiment the body 102 has a width of at least two centimeters. More particularly still, in the present embodiment, in which the body 102 has a generally cylindrical shape, the body has a diameter of two centimeters.

Advantageously, as mentioned above, the shape and dimensions of the body 102 tend to allows the apparatus 100 to be more easily gripped and pulled by a user, allowing the user to apply significant amounts of force without the abrasion or other discomfort that tend to result from typical conventional tighteners. Alternatively, other suitable shapes and dimensions may be substituted.

In the present embodiment, the grabber 104 is generally tongue-shaped. As shown in FIGS. 1 and 3, in this embodiment the grabber 104 extends generally circumferentially and radially outwardly from an outer surface 108 of the body 102 at a central region 110 of the body 102. In the present embodiment, the grabber 104 includes a base portion 112 at which the grabber merges with the body, and a tip portion 114 narrower than the base portion 112. As noted, such a grabber tends to more easily slide under a lace or other cord without causing wear, and tends to prevent the cord from becoming dislodged from the groove during tightening. Such a grabber also allows the cord to be tightened by pulling the body in a direction substantially perpendicular to its axis, tending to prevent the apparatus from slipping out of the user's hand during tightening.

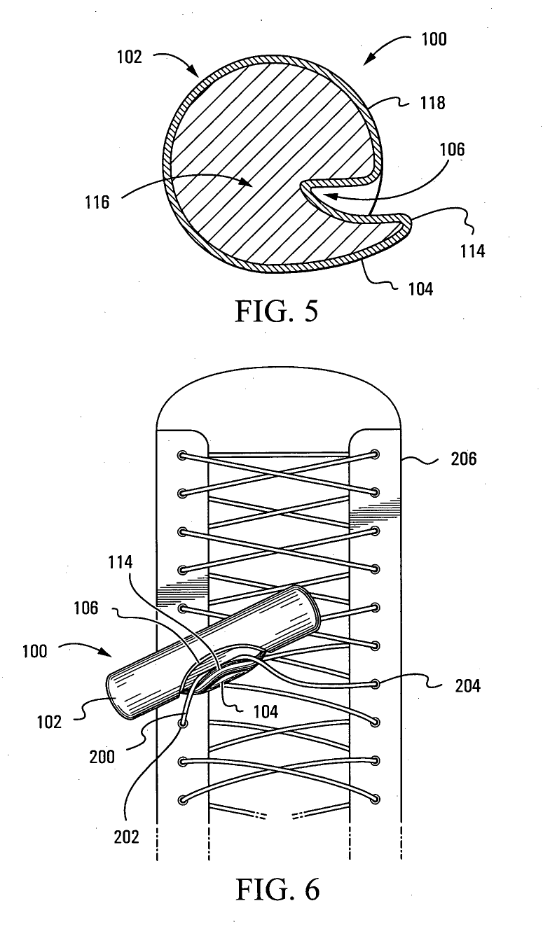

Referring to FIG. 5, in this embodiment the body 102 and the grabber 104 are rigid. More particularly, in this embodiment the body 102 and the grabber 104 are formed from a single mold. In this regard, as shown in FIG. 5, in this embodiment the body 102 and the grabber 104 include an inner core material 116, of which the body and the grabber have been molded. In this embodiment, the inner core material 116 includes a plastic, or more particularly, a plastic resin, which has been poured in liquid form into a mold (not shown) and has then hardened, to form the body 102 and the grabber 104. Alternatively, however, other resins, other plastics, or more generally, any other suitable material may be substituted, and likewise, methods of manufacture other than molding may also be substituted. Advantageously, the rigidity of the body 102 resists flexing and thus assists the user to more easily apply force to the apparatus 100 to tighten the cord. However, although a rigid material is preferred for the body 102 and the grabber 104 to facilitate tightening of a cord using the apparatus 100, alternatively, suitable flexible materials may be substituted for a particular application, if desired.

Still referring to FIG. 5, in this embodiment the body 102 and the grabber 104 further include an outer coating 118. In the present embodiment, the outer coating 118 includes a resiliently deformable material. More particularly, in this embodiment the resiliently deformable material includes rubber. In this embodiment, the material of the outer coating 118 has been selected to provide a desired amount of friction between the outer coating and the cord. As noted, such outer coatings advantageously tend to reduce abrasion or other discomfort to the user's hands, while also improving the grip of the cord in the groove. Alternatively, such outer coatings may be omitted if desired. For example, the body and the grabber may be formed of a single homogenous material such as rubber, which may provide adequate resistance to flexing to facilitate tightening of the cord, while still providing sufficient resilient deformability to provide improved grip on the cord and improved comfort for the user. Or, as a further example, such resilient deformability may be omitted entirely.

Operation

Referring to FIGS. 2 and 6-9, a method of tightening a cord according to one exemplary embodiment of the invention is illustrated. Generally, in this embodiment the method includes gripping a cord in a groove defined between a grabber of a tightener and a body of the tightener, and further includes pulling the tightener.

More particularly, in this embodiment the tightener includes the apparatus 100, and therefore, in this embodiment the body, the grabber and the groove of the tightener employed in the exemplary embodiment of the method include the body 102, the grabber 104, and the groove 106 of the apparatus 100 shown in FIG. 2.

In this exemplary embodiment, the cord includes a lace portion 200 extending between eyelets 202 and 204 of a footwear item 206 shown in FIG. 6, and the groove 106 is configured to grip the lace portion 200 therein. More particularly, in this embodiment the footwear item 206 includes a skate, which in the present embodiment is an ice skate, or more particularly still, an ice-hockey skate. Thus, in the present embodiment the lace portion 200 is a skatelace portion extending between the eyelets 202 and 204 of the skate, and the groove 106 is configured to grip the skatelace portion therein. Accordingly, in the present embodiment, gripping a cord includes gripping the lace portion 200 extending between the eyelets 202 and 204 of the footwear item 206, which in this illustrative example is a skatelace portion extending between eyelets of a skate. Alternatively, however, embodiments of the invention may be useful for tightening laces of footwear items other than skates, or for tightening cords other than footwear item laces.

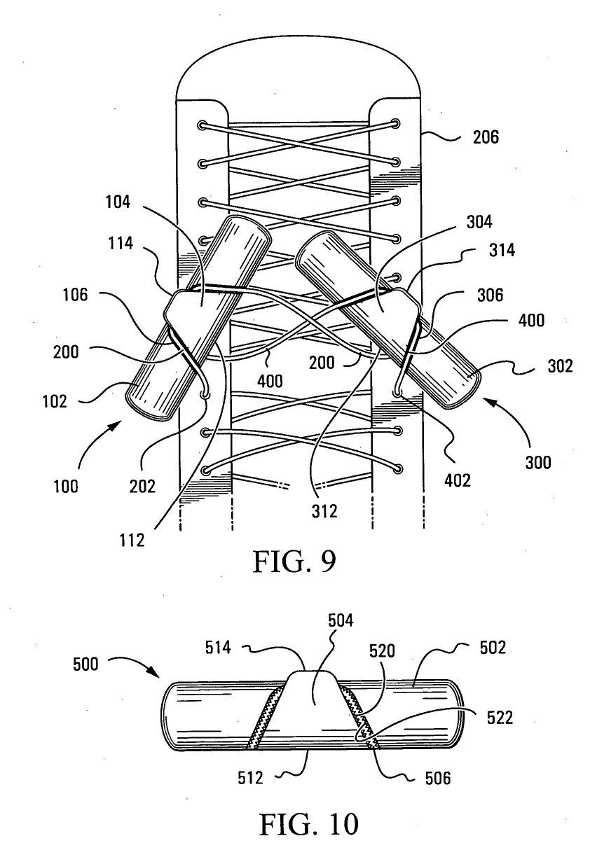

In the present embodiment, although a single tightener such as the apparatus 100 may be used by itself if desired, in this embodiment a system including first and second apparatuses 100 and 300 is provided, as shown in FIGS. 8 and 9. In this embodiment, the second apparatus 300 is identical to the apparatus 100, and thus includes a body 302, and a grabber 304 extending from the body 302 and defining a groove 306 therebetween configured to grip a cord therein. The grabber 304 is identical to the grabber 104, and thus includes a base portion 312 shown in FIG. 9, and a tip portion 314 narrower than the base portion 312. In this illustrative example, the cord gripped by the second apparatus 300 includes a second lace portion 400, extending between an eyelet 402 and another eyelet (not shown, concealed beneath the first apparatus 100 in FIGS. 6-9) of the footwear item 206. Thus, in this embodiment the respective grooves 106 and 306 of the apparatuses 100 and 300 are configured to grip first and second respective cord portions, or more particularly, first and second respective skatelace portions, therein.

Referring back to FIG. 6, in this embodiment the grabber 104 is configured to grab the cord, which in this example is the lace portion 200. More particularly, in this embodiment the grabber is insertable under the cord to grab the cord. More particularly still, as noted above, in this embodiment the grabber 104 is generally tongue-shaped and includes the tip portion 114 insertable under the cord to grab the cord.

Thus, in this embodiment, gripping the cord begins with grabbing the cord, which in this embodiment is achieved by inserting the grabber 104 under the cord, or more particularly, by inserting the tip portion 114 of the grabber 104 under the lace portion 200.

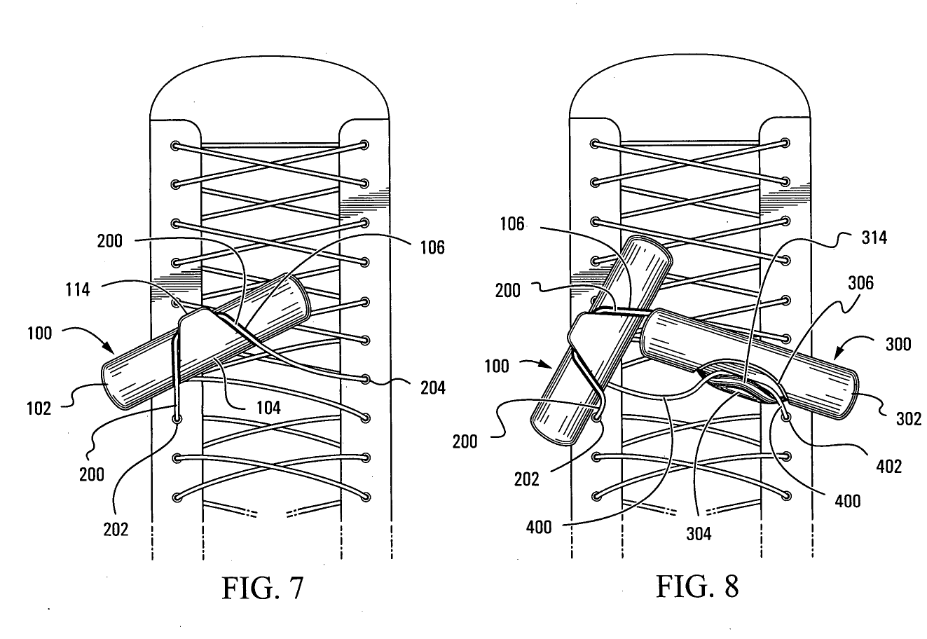

Referring to FIGS. 6 and 7, in this embodiment, the body 102 is rotatable about a central axis thereof to grip the cord in the groove 106. Thus, in this embodiment gripping the cord further includes rotating the tightener about the central axis thereof to grip the cord in the groove. More particularly, as shown in FIG. 7, the apparatus 100 is rotated about the central axis of the body 102, to grip the lace portion 200 in the groove 106.

If desired, the lace portion 200 may then be immediately tightened by pulling the apparatus 100. However, in this embodiment, in which the first and second apparatuses 100 and 300 are used to tighten the lace portions 200 and 400, it is generally easier for a user to first use both apparatuses 100 and 300 to grip the lace portions 200 and 400 in the respective grooves 106 and 306, and then to simultaneously pull the bodies 102 and 302 to tighten the lace portions 200 and 400.

Accordingly, referring to FIGS. 8 and 9, in this embodiment gripping a cord includes gripping a first lace portion in a first groove defined between a grabber of a first tightener and a body of the first tightener, and gripping a second lace portion in a second groove defined between a grabber of a second tightener and a body of the second tightener. More particularly, after gripping the first lace portion 200 in the groove 106 of the apparatus 100 as described above, the second lace portion 400 is then gripped in the second groove 306 defined between the grabber 304 of the apparatus 300 and the body 302 of the apparatus 300. To achieve this, in this embodiment the tip portion 314 of the grabber 304 is inserted under the lace portion 400 as shown in FIG. 8, and the apparatus 300 is then rotated about a central axis of the body 302 to grip the lace portion 400 in the groove 306, as shown in FIG. 9.

Finally, in this embodiment, pulling the cord includes pulling the first and second tighteners, which in this embodiment include the first and second apparatuses 100 and 300. In the present embodiment, each one of the bodies 102 and 302 is pullable in a direction non-parallel to its central axis, or more particularly, in a direction substantially perpendicular to its central axis. Thus, to tighten the lace portion 200, in this embodiment the body 102 of the apparatus 100 is pulled in a direction substantially perpendicular to its central axis, in a direction upward and away from the footwear item 206 shown in FIG. 9, while the body 302 of the apparatus 300 is simultaneously pulled in a direction substantially perpendicular to its own central axis, to tighten the lace portion 400. Advantageously, the perpendicularity of the pulling direction relative to the central axis tends to reduce or prevent slippage of the cord in the groove.

To tighten the lace portions of the entire footwear item 206, in this embodiment the apparatuses 100 and 300 are used in the above manner to tighten successive pairs of crossing lace portions similar to the pair of lace portions 200 and 400, commencing with a pair of crossing lace portions closest to a toe region of the footwear item 206, and ending with a pair of lace portions closest to an ankle region of the footwear item.

Referring back to FIGS. 1 and 5, in the foregoing illustrative embodiment, it will be appreciated that the grabber 104 is an example of means for grabbing a cord, and the groove 106 defined between the grabber 104 and the body 102 is an example of means for gripping the cord between the means for grabbing and the body 102. Similarly, it will be appreciated that each of the manually-grippable shape of the body 102, and the resiliently deformable outer coating 118, acts as an example of means for facilitating pulling of the body 102.

Alternatives

Referring to FIGS. 1 and 10, an apparatus for tightening a cord according to a second embodiment of the invention is shown generally at 500. In this embodiment, the apparatus 500 is generally similar to the apparatus 100 shown in FIG. 1, and thus includes a body 502, and a grabber 504 extending from the body 502 and defining a groove 506 therebetween configured to grip the cord therein. The grabber 504 is generally similar to the grabber 104, and is thus generally tongue-shaped and includes a base portion 512 and a tip portion 514 narrower than the base portion.

However, in this embodiment the apparatus 500 further includes a plurality of teeth extending from at least one of the body 502 and the grabber 504 within the groove 506. More particularly, in this embodiment the plurality of teeth includes a first row 520 of teeth extending from the grabber 504 within the groove 506, and further includes a second row 522 of teeth extending from the body 502 within the groove 506. In this embodiment, the second row 522 of teeth is configured to interlock with the first row 520 of teeth, leaving a small space between the rows of teeth in which to grip the cord under compression.

In this regard, such rows of teeth may be particularly advantageous for applications in which lateral slippage of the cord within the groove may tend to occur, as such teeth improve the ability of the groove 506 to grip the cord therein. However, depending upon the particular application and the particular type of cord in question, such teeth may tend to increase wear of the cord, and thus, there may be a trade-off between improved grip and increased wear for some applications.

Referring back to FIG. 1, as a further illustrative alternative, if desired, the body 102 of the apparatus 100 may be modified to include finger grips. For example, such finger grips may include indentations (not shown) designed to accommodate the fingers of a user, in order to further facilitate gripping and pulling of the apparatus 100 by the user. If desired, such apparatuses may be manufactured in a range of respective sizes, to accommodate varying hand-sizes of intended users.

Although the foregoing illustrative example involves use of a specific embodiment of the invention to tighten ice-hockey skate laces, alternatively, embodiments of the invention may be used for tightening laces of footwear items other than ice skates, such as in-line skates or other roller skates, or ski boots or other boots, for example. More generally, embodiments of the invention may be for tightening cords other than footwear item laces. For example, an embodiment of the invention may be employed on a boat or ship, to allow a user to tighten lines or other cords, thereby avoiding abrasion or other discomfort that would result if the user conventionally tightened such lines without the benefit of an embodiment of the present invention.

More generally, while specific embodiments of the invention have been described and illustrated, such embodiments should be considered illustrative of the invention only and not as limiting the invention as construed in accordance with the accompanying claims.

1. An apparatus for tightening a cord, the apparatus comprising:
a) a body; and
b) a grabber extending from the body and defining a groove therebetween configured to grip the cord therein.

2. The apparatus of claim 1 wherein the body has a shape configured to be manually grippable.

3. The apparatus of claim 2 wherein the body has a generally cylindrical shape.

4. The apparatus of claim 2 wherein the body has a length at least as great as a width of an intended user's hand.

5. The apparatus of claim 4 wherein the body has a length of at least one-half decimeter.

6. The apparatus of claim 4 wherein the body has a length of at least one decimeter.

7. The apparatus of claim 2 wherein the body has a width of at least one centimeter.

8. The apparatus of claim 2 wherein the body has a width of at least two centimeters.

9. The apparatus of claim 1 wherein the grabber is generally tongue-shaped.

10. The apparatus of claim 9 wherein the grabber extends generally circumferentially and radially outwardly from an outer surface of the body at a central region thereof.

11. The apparatus of claim 10 wherein the grabber comprises a base portion at which the grabber merges with the body, and a tip portion narrower than the base portion.

12. The apparatus of claim 1 wherein the body and the grabber are rigid.

13. The apparatus of claim 1 wherein the body and the grabber are formed from a single mold.

14. The apparatus of claim 1 wherein the body and the grabber comprise an inner core material.

15. The apparatus of claim 14 wherein the inner core material comprises a plastic.

16. The apparatus of claim 14 wherein the inner core material comprises a resin.

17. The apparatus of claim 14 wherein the body and the grabber further comprise an outer coating.

18. The apparatus of claim 17 wherein the outer coating comprises a resiliently deformable material.

19. The apparatus of claim 18 wherein the resiliently deformable material comprises rubber.

20. The apparatus of claim 17 wherein the outer coating comprises a material selected to provide a desired amount of friction between the outer coating and the cord.

21. The apparatus of claim 1 further comprising a plurality of teeth extending from at least one of the body and the grabber within the groove.

22. The apparatus of claim 1 wherein the grabber is configured to grab the cord.

23. The apparatus of claim 22 wherein the grabber is insertable under the cord to grab the cord.

24. The apparatus of claim 22 wherein the grabber is generally tongue-shaped and comprises a tip portion insertable under the cord to grab the cord.

25. The apparatus of claim 22 wherein the body is rotatable about a central axis thereof to grip the cord in the groove.

26. The apparatus of claim 25 wherein the body is pullable in a direction non-parallel to the central axis of the body.

27. The apparatus of claim 26 wherein the body is pullable in a direction substantially perpendicular to the central axis of the body.

28. The apparatus of claim 1 wherein the cord comprises a lace portion extending between eyelets of a footwear item, and wherein the groove is configured to grip the lace portion therein.

29. The apparatus of claim 1 wherein the cord comprises a skatelace portion extending between eyelets of a skate, and wherein the groove is configured to grip the skatelace portion therein.

30. A system comprising first and second apparatuses as defined by claim 1, the respective grooves of which are configured to grip first and second respective cord portions therein.

31. A system comprising first and second apparatuses as defined by claim 29, the respective grooves of which are configured to grip first and second respective skatelace portions therein.

32. A method of tightening a cord, the method comprising:
gripping a cord in a groove defined between a grabber of a tightener and a body of the tightener; and
pulling the tightener.

33. The method of claim 32 wherein gripping comprises grabbing the cord.

34. The method of claim 33 wherein grabbing comprises inserting the grabber under the cord.

35. The method of claim 34 wherein gripping further comprises rotating the tightener about a central axis thereof to grip the cord in the groove.

36. The method of claim 35 wherein pulling comprises pulling the tightener in a direction non-parallel to the central axis of the tightener.

37. The method of claim 36 wherein pulling comprises pulling the tightener in a direction substantially perpendicular to the central axis of the tightener.

38. The method of claim 32 wherein gripping a cord comprises gripping a lace portion extending between eyelets of a footwear item.

39. The method of claim 38 wherein gripping a lace portion comprises gripping a skatelace portion extending between eyelets of a skate.

40. The method of claim 38 wherein gripping comprises gripping a first lace portion in a first groove defined between a grabber of a first tightener and a body of the first tightener, and gripping a second lace portion in a second groove defined between a grabber of a second tightener and a body of the second tightener, and wherein pulling comprises pulling the first and second tighteners.

41. An apparatus for tightening a cord, the apparatus comprising:
a body;
means for grabbing the cord; and
means for gripping the cord between the means for grabbing and the body.

42. The apparatus of claim 41 further comprising means for facilitating pulling of the body.
